(19) United States
(12) Patent Application Publication
(10) Pub. No.: US 2014/0172523 A1
(43) Pub. Date: Jun. 19, 2014

(54) Hand/Surface-Sanitizing Kiosk with Ad Space

(71) Applicants: David J. Stob, Placida, FL (US); Keith Haluska, Bradenton, FL (US)

(72) Inventors: David J. Stob, Placida, FL (US); Keith Haluska, Bradenton, FL (US)

(21) Appl. No.: 13/715,307

(22) Filed: Dec. 14, 2012

(51) Int. Cl. G06Q 30/02; A47K 5/12

(52) U.S. Cl. CPC G06Q 30/0241; A47K 5/12
USPC 705/14.4; 222/173; 222/608; 222/626; 222/25

(57) ABSTRACT

A vertical elongated kiosk with a floor-engaging portion is equipped with a handle and optional wheels adjacent a rear surface to facilitate is mobility. A deck region has a dispenser which may include a spout from which hand/surface sanitizer is dispensed in response to a motion sensor. Electrical power is provided alternatively by a storage battery which may be recharged by a solar panel or an ac outlet plug. A wireless receiver/transmitter communicates with a remote base computer to control and monitor the operation of the kiosk. Informational displays, both video and placard, can be accommodated and a business card dispenser provided.

This application is a continuation of application Ser. No. 13/068,424 which is a continuation-in-part of application Ser. No. 12/378,252 filed Feb. 11, 2009 which is a continuation-in-part of application Ser. No. 12/231,084 filed Nov. 26, 2008 which are each incorporated by reference.

### BACKGROUND AND SUMMARY OF THE INVENTION

The present invention is directed to the field of personal hygiene. More particularly, the present invention is directed to a hand/surface-sanitizing kiosk that dispenses a cleansing product and features significant surface area for posting informational/promotional messages in electronic or print media.

As more and more medical information becomes available regarding the mechanism of transmission of various diseases from surfaces to hand or mouth/nasal region, people are being made aware of the importance of sanitizing their hands and surfaces in public places as a disease avoidance technique. In addition, in public areas, particularly those featuring high foot traffic, it is advantageous for not only the employees, but the patrons, to have ready access to a means to sanitize their hands.

It is an object of the present invention to provide an advertising vehicle that provides out-of-home advertising, promotional, or informational messages for the public domain. Advertisers are seeking new and inventive ways to communicate their message to the public, a need which the kiosk of the present invention answers. The hand/surface-sanitizing kiosk of the present invention includes a) a vertical support structure including a floor-engaging portion and a station from which a waterless cleanser is dispensed; b) a dispenser for delivering a quantity of hand/surface cleanser to the station; c) a mechanism to track the number of users frequenting the kiosk; d) surface area(s) for supporting advertising/promotional/informational messages delivered in print, electronic and digital media or any other message delivery medium or device. The station comprises an region positioned approximately waist high, with a device which dispenses the hand/surface cleanser. The primary embodiment includes a spout, a container for the hand/surface cleanser, a pump for delivering the waterless cleanser from the container to the spout, and a storage battery for powering the pump. It will be understood that the term “waterless” distinguishes the present cleanser from water-based soaps and is not intended to convey that the cleanser is water free, simply that it has a very small percentage of water in its formulation. Further, although the preferred embodiment is depicted with a battery-powered pump, it will be appreciate that the kiosk can be configured with a plug suitable for insertion into a conventional ac outlet. Support means is provided, preferably with the option of wheels, leg stabilizers, or a flat surface beneath the floor-engaging portion for, alternatively, facilitating movement or permanent installation of the kiosk, as the needs of the customer warrant. At least a portion of the plurality of wheels/leg stabilizers are positioned adjacent a rear edge of the floor- engaging portion and a handle situated at a top rear portion above the at least a portion of the wheels or leg stabilizers, enabling the hand/surface-sanitizing kiosk to be rocked backward onto the at least a portion of the wheels or leg stabilizers, hand-dolly style, for transport.

Preferably, another option would include the provision of a solar collector for recharging the storage battery. A motion sensor is associated with the spout or discharge orifice for activating the pump to deliver a measured quantity of hand/surface cleanser through the spout. Also included are a plurality of sensors for gathering data by monitoring a) levels of the waterless cleanser in the container; b) power levels in the storage battery; c) regulatory compliance information relating to time and number of activations of the motion sensor; d) location of the hand/surface-sanitizing kiosk. Wireless transmission means is provided to transmit the data to a remote computer server. Wireless receiving means enables the computer server to remotely adjust operation of the hand/surface-sanitizing kiosk.

The kiosk includes substantially flat regions located on exterior surface portions of the rectangular body of the kiosk to mount graphic displays. These graphic displays are selected from a group consisting of a) regulatory-compliant tutorials on the use of the kiosk; b) advertising; c) informational blurbs. The displays are preferably presented on panels supporting graphic print, and/or a digital/electronic screen device.

Various other features, advantages, and characteristics of the present invention will become apparent after a reading of the following detailed description.

### BRIEF DESCRIPTION OF THE DRAWINGS

The preferred embodiments of the present invention are described in conjunction with the associated drawings in which like features are indicated with like reference numerals and in which

FIG. 1 is a schematic enlarged front view of a first embodiment of the hand/surface-sanitizing kiosk of the present invention;

FIG. 2 is a side view of the first embodiment;

FIG. 3 is a bottom view of the first embodiment;

FIG. 4 is a top view of the first embodiment;

FIG. 5 schematic depiction of the base receiving ballast;

FIG. 6A is a perspective view of a solar cell used with the first embodiment;

FIG. 6B is a perspective view of a storage battery which can be used;

FIG. 6C is a perspective view of a voice activation unit of a type which may be used;

FIG. 6D is a perspective view of a motion sensor light useful with the first embodiment;

FIG. 7 is a schematic rear view with the operational equipment shown in the detail;

FIG. 8 is a schematic electrical diagram showing the interconnections of the elements;

FIG. 9 is a front view of a second embodiment of the kiosk of the present invention;

FIG. 10 is a top view of a third embodiment of the kiosk of the present invention;

FIG. 11 is a detail front perspective view of the hardware used on the kiosk to attach posters and other adware to the flat surfaces of the kiosk;

FIG. 12A is a front view of the third embodiment of the kiosk; and,

FIG. 12B is a front perspective view of the third embodiment.

### DETAILED DESCRIPTION OF THE PREFERRED EMBODIMENT(S)

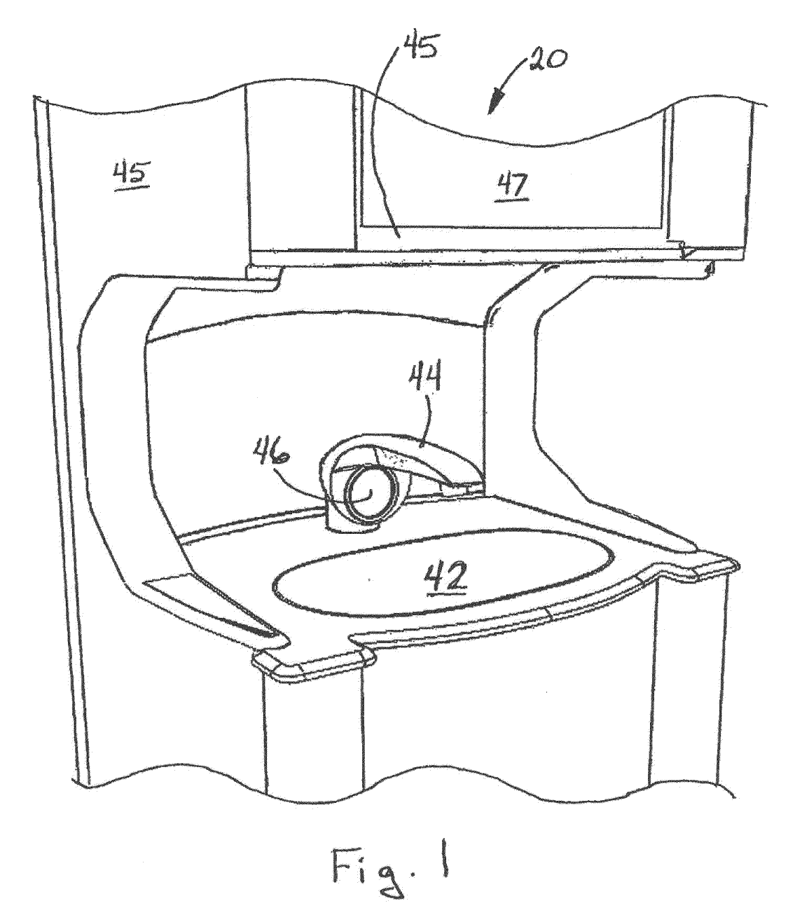

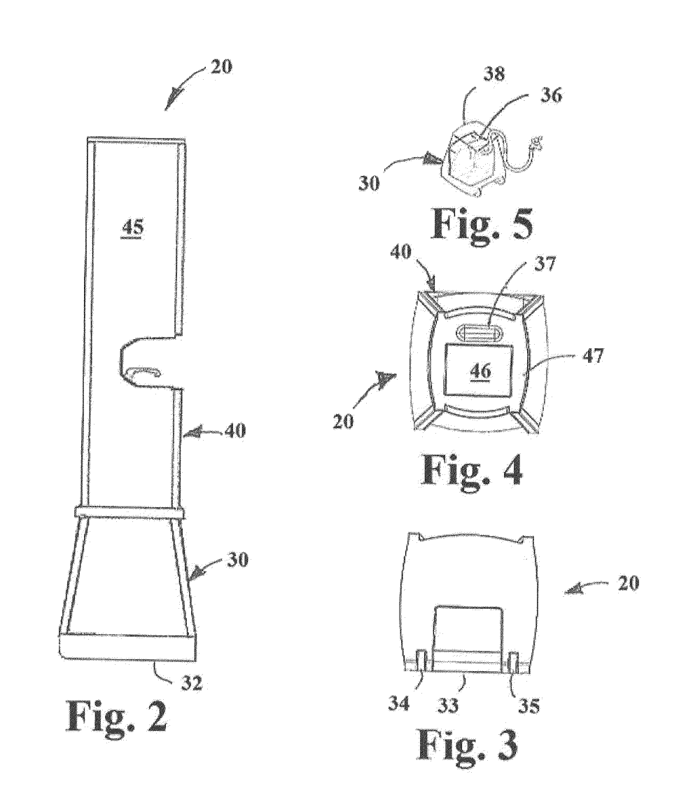

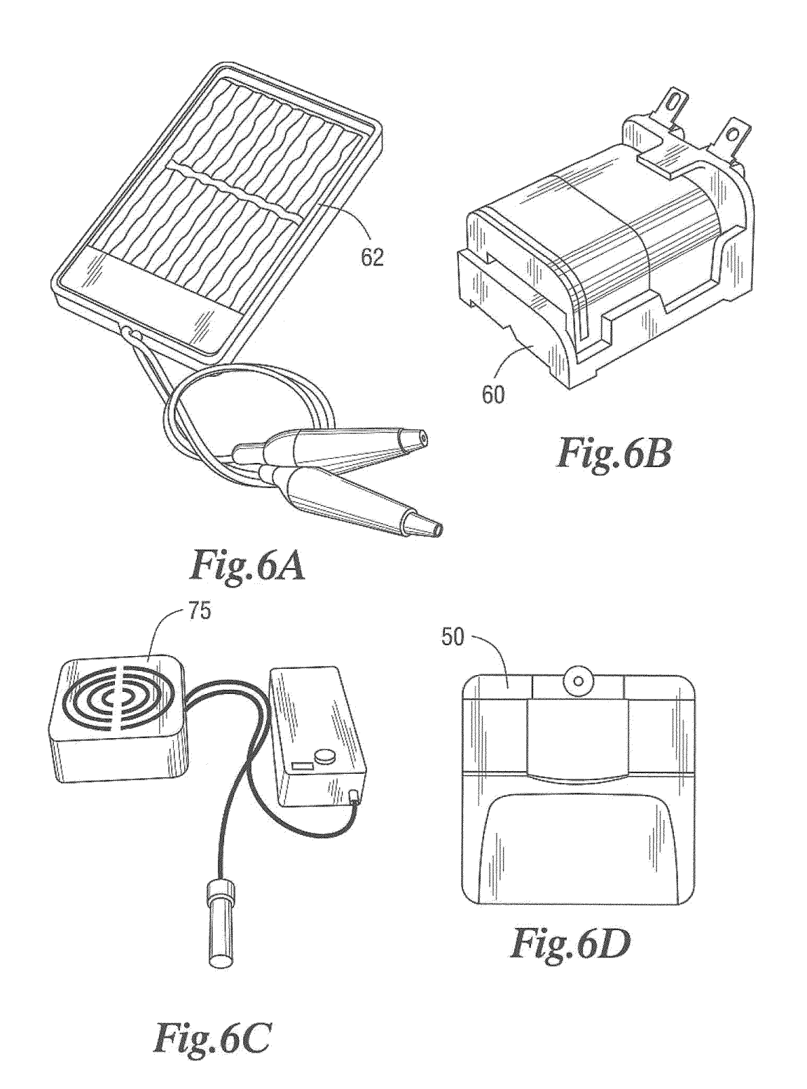

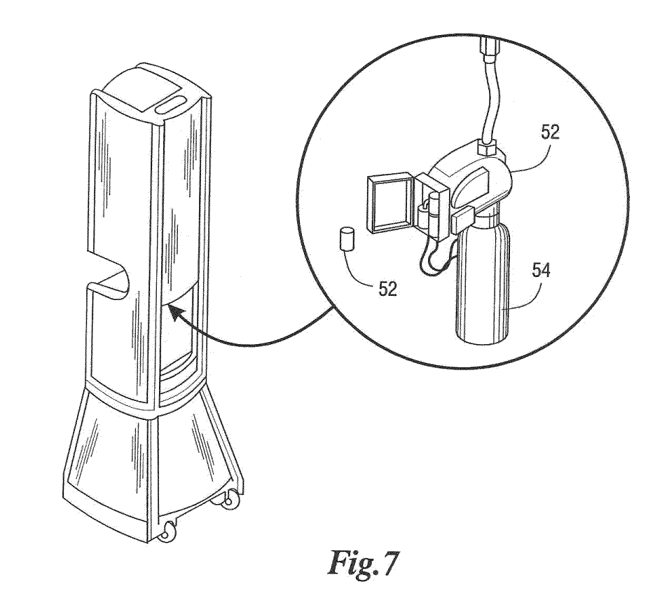

A first embodiment of the hand/surface-sanitizing kiosk of the present invention is depicted in FIGS. 1-4 generally at 20. Kiosk 20 comprises a vertical support structure which includes a base 30 (FIG. 2) and an elongated rectangular body 40 which is attached thereto and sits on top of the base 30. Base 30 has a floor-engaging portion 32 and a support means in the form of a plurality of wheels 34, 35 (FIG. 3), at least two of which are positioned adjacent rear edge 33 of floor-engaging portion 32. Handle 37 is situated on a top 47 of kiosk 20 directly above wheels 34, 35 (FIG. 4) to enable the kiosk to be rocked back onto the wheels hand-dolly style, making it easily portable. Both the base 30 and body 40 are made of a light-weight, durable plastic material and, accordingly, to provide the kiosk 20 with stability, an inflatable plastic jug 36 is inserted through the open top 38 of base 30 and filled with water as shown in FIG. 5. Body 40 of kiosk 20 has a station from which hand/surface sanitizer is dispensed comprised of a central sink-like area 42 with a spout-like member 44. The unit's dispenser is comprised of pump 52 and a supply container 54 (FIG. 7). A motion sensor light 50 of the type shown in FIG. 6D is positioned behind viewport 46 to activate pump 52 which dispenses waterless hand cleanser from container 54 for receipt beneath faucet-like member 44. Waterless hand cleanser may take the form of a lotion, gel, foam, spray or hand wipe without departing from the scope of the invention.

A rechargeable lithium battery pack 60 of the type shown in FIG. 6B most preferably powers the pump 52, as well as all the sensors utilized in the system. A less desirable alternative is to use replaceable batteries 53 of the type shown in FIG. 7. However, in the preferred embodiment, a solar panel 62 of the type shown in FIG. 6A is situated in a recess 46 on the top 47 of the body 40 to recharge lithium battery pack 60. Solar panel 62 is most preferably of the type that converts natural or artificial light to energy such that the solar panel 62 and battery pack 60 are designed to provide the energy needs of the kiosk 20 throughout its useful life. Obviously, both the solar panel 62 and battery pack 60 can be readily changed, if necessary.

Flat regions 45 are positioned on sides of the kiosk 20 including one immediately above station 42 which receives graphic displays, such as Digital Media screen 58. Graphic displays may include a) regulatory-compliant tutorials on the use of the kiosk; b) advertising; c) informational blurbs regarding the rules of the establishment, for example. The Digital Media screen 58 can be designed to provide the informational tutorial on the use/operation of the kiosk 20 that may be voice activated by installing a voice activation module 75 of the type depicted in FIG. 6C.

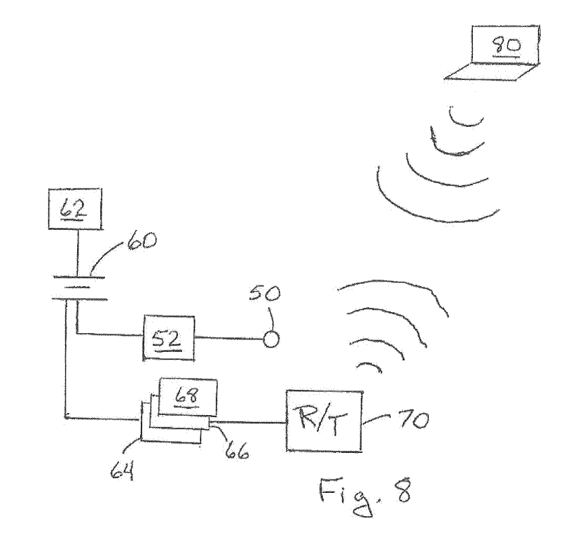

A schematic electrical diagram is shown in FIG. 8. Solar panel 62 re-energizes battery pack 60 that powers pump 52 in response to motion sensor light 50. In addition, battery pack 60 supplies the power needs of cleanser level sensor 64, timing and number of activations sensor 66, and position sensor 68 which preferably comprises a GPS sensor. The time and number of activations sensor 66 is required for regulatory compliance within certain establishments, particularly food handling operations such as restaurants. The sensor information is fed to a wireless receiver/transmitter 70, shown here as a single unit, which relays the data to a remote base computer 80. Information may be transmitted from the computer 80 to the receiver/transmitter 70 to control the amount of sanitizer dispensed for each activation.

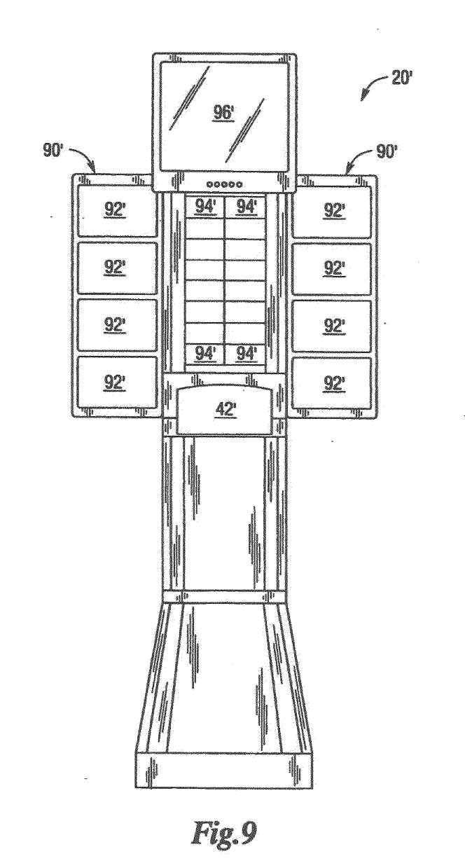

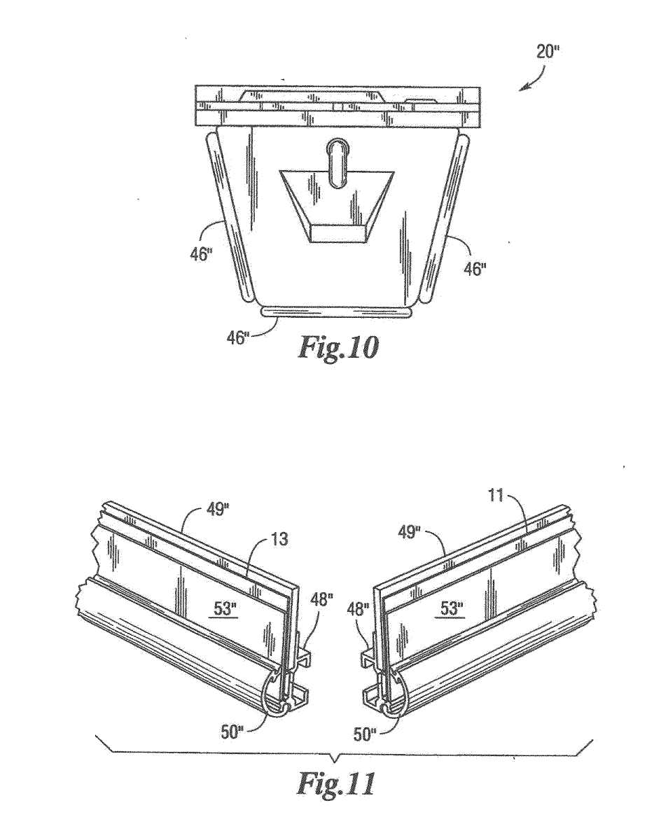

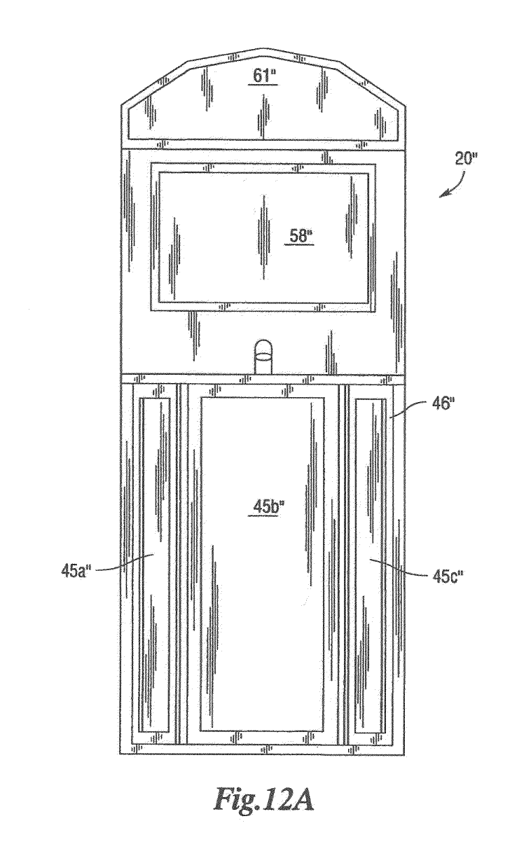

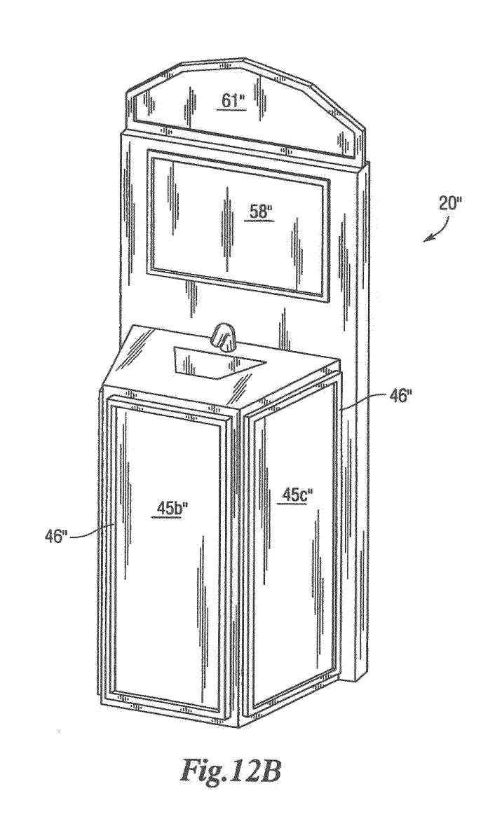

A second embodiment of the hand/surface-sanitizing kiosk of the present invention is depicted in FIG. 9 generally at 20′. Second embodiment 20′, in addition to performing the primary function of dispensing hand cleanser from sink region 42′, optionally, has two laterally protruding wings 90′ with a plurality of compartments 92′ to receive advertising/informational placards. The center section beneath video monitor 96′, has a plurality of sleeves 94′ with a clear vinyl windows to display/dispense business cards. Space afforded by compartments 92′ and sleeves 94′ can be rented by the owner of kiosk 20′ to those wishing to advertise on/distribute business cards from the hand/surface-sanitizing kiosk 20′. Monitor 96′ may constitute a TV monitor which may feature closed circuit ads, informational videos on the proper use of kiosk 20′, or any other desired materials. A third embodiment of the hand/surface-sanitizing kiosk of the present invention is depicted in FIGS. 10-12B generally at 20″. The hand-surface sanitizing kiosk 20″ functions as the other embodiments with a key feature being in the way the advertising placards and informational blurbs are attached to the unit. As shown in FIGS. 12A and 12B, each of the planar display areas 45a″, 45b″, and 45c″ have a picture frame 46″ surrounding the respective display area. These picture frames 46″ are made of four lengths of gripping angle iron 48″. As seen in FIG. 11, an edge 11, 13 of a placard is secured between backing plate 49″ and C-frame 50″ which pivots about a hinge 51″ between an open, loading position and the gripping position shown in FIG. 11. A clear plastic sheet 53″ is provided to protect the placards 11, 13. As with the earlier embodiments, an Digital Media screen 58″ is provided for display of visual/promotional advertising, instructional videos, news media, etc. Arched station sign 61″ is provided to identify the purpose of the kiosk 20″.

Also contemplated in the present invention is a method of doing business/promoting a revenue stream. The kiosk 20 can be located in a high-traffic area where sanitization is needed such as the lobby of a bank, a food court, crossroads in a mall, etc. The activation sensor 66 will track the number of times sanitizer is obtained from the kiosk 20 with that information being supplied to remote base computer 80. This data can be used to compute the effectiveness of the advertising media. Revenue from the advertising on kiosk 20, both from placards and electronic ads, will be shared between at least two of i) the manufacturer of kiosk 20, ii) the retailer placing the kiosk 20 in its establishment, and iii) an advertising broker who sells the ad space. In addition to the effectiveness numbers, a camera (not shown) can be employed to provide demographic data on the users including age, time spent viewing each ad segment, etc.

The hand/surface-sanitizing kiosk 20 of the present invention addresses the sanitation needs of a plurality of industries. The light-aluminum from which it is made facilitates shipping and affords the capability of manufacturing the unit 20 in a variety of colors and powder-coated finishes including some having a granite appearance. In addition, kiosk 20 is highly durable with electronics which should last the life of the unit and/or be easily changed out with replacement parts.

Various changes, alternatives, and modifications will become apparent to a person of ordinary skill in the art after a reading of the foregoing specification. It is intended that all such changes, alternatives, and modifications as fall within the scope of the appended claims be considered part of the present invention.

1. A hand/surface-sanitizing kiosk/station comprising
a) a vertical support structure including a floor-engaging portion and a station from which a hand/surface cleanser is dispensed;
b) a dispenser for delivering a quantity of hand/surface cleanser to said station;
c) external surface area adapted to receive advertising/promotional/informational messages or any type.

2. The hand/surface-sanitizing kiosk of claim 1 wherein said station comprises an area positioned waist high, said area resembling a sink with a spout.

3. The hand/surface-sanitizing kiosk of claim 2 said dispenser including a container for said hand/surface cleanser, a pump for delivering said hand/surface cleanser from said container to an orifice in said area, and an energy source for powering said pump.

4. The hand/surface-sanitizing kiosk of claim 3 wherein said energy source is selected from the group consisting of a storage battery and an electrical cord which is plugged into an ac outlet.

5. The hand/surface-sanitizing kiosk of claim 4 further comprising a solar collector for recharging said storage battery.

6. The hand/surface-sanitizing kiosk of claim 1 further comprising support means beneath said floor engaging portion for stabilizing said hand/surface-sanitizing kiosk.

7. The hand/surface-sanitizing kiosk of claim 6 wherein said support means comprises a plurality of wheels.

8. The hand/surface-sanitizing kiosk of claim 1 further comprising substantially flat regions located on exterior surface portions of said rectangular body to mount graphic displays.

9. The hand/surface-sanitizing kiosk of claim 8 wherein said graphic displays are selected from a group consisting of a) regulatory-compliant tutorials on the use of said kiosk; b) advertising placards; c) informational blurbs; d) business cards; e) video broadcasts; and, 0 any type of digital and visual/graphic messaging.

10. The hand/surface-sanitizing kiosk of claim 8 wherein said graphic displays are presented on an electronic digital video/imaging display.

11. A hand/surface-sanitizing kiosk comprising
a) an elongated rectangular body, said body including a floor engaging portion and a waist-high station resembling a sink;
b) a dispenser for delivering a quantity of hand/surface cleanser, said dispenser including a container for said hand/surface cleanser, a pump for delivering said hand/surface cleanser from said container to said area, and a battery for powering said pump;
c) substantially flat regions located on exterior surface portions of said rectangular body to mount static and electronic graphic displays.

12. The portable hand/surface-sanitizing kiosk of claim 11 wherein said graphic displays are selected from a group consisting of a) regulatory-compliant tutorials on the use of said kiosk; b) advertising placards; c) informational blurbs; d) business cards; e) video broadcasts.

13. The portable hand/surface-sanitizing kiosk of claim 11 wherein said graphic displays are presented on a video monitor and feature both onsite and remote content management capabilities.

14. The portable hand/surface-sanitizing kiosk of claim 11 further comprising a plurality of wheels mounted adjacent a lower rear edge of said floor-engaging portion to facilitate transport of said portable hand/surface-sanitizing kiosk.

15. The portable hand/surface-sanitizing kiosk of claim 11 further comprising sensors for gathering data by monitoring a) levels of said waterless cleanser in said container; b) power levels in said storage battery; c) regulatory compliance information relating to time and number of activations of said motion sensor; d) location of said portable hand/surface-sanitizing kiosk; e) wireless communication to cell phones; f) facial recognition of persons using the cleanser; g) ad content and scheduling; and, h) coupon dispensing.

16. The portable hand/surface-sanitizing kiosk of claim 11 further comprising wireless transmission means to transmit said data to a computer server and wireless receiving means enabling the computer server to remotely adjust operation of said portable hand/surface-sanitizing kiosk.

17. A business method of generating a revenue stream comprising the steps of
a) positioning a portable hand-surface sanitizing kiosk in a retail establishment;
b) selling ad space for placards on a plurality of external surfaces of said kiosk;
c) selling electronic advertising messages to be shown on a video screen secured to a portion of said kiosk;
d) dividing said revenue stream between a plurality of parties.

18. The business method of claim 17 wherein said plurality of parties include at least two of i) a manufacturer of said kiosk, ii) an owner of said retail establishment and iii) a broker responsible for selling said ad space.
